(19) United States
(12) Patent Application Publication
(10) Pub. No.: US 2018/0218447 A1
(43) Pub. Date: Aug. 2, 2018

(54) SYSTEMS AND METHODS FOR GENERATING LENDING SCORES USING TRANSACTION DATA

(71) Applicant: MasterCard International Incorporated, Purchase, NY (US)

(72) Inventors: Manash Bhattacharjee, Jersey City, NJ (US); Prashanna S. Tiwaree, New York, NY (US); Prashant Sharma, Madison, NJ (US)

(21) Appl. No.: 15/421,131

(22) Filed: Jan. 31, 2017

(51) Int. Cl. G06Q 40/02

(52) U.S. Cl. CPC G06Q 40/025

(57) ABSTRACT

A merchant score (MS) computing device for generating merchant lending scores for business loans is provided. The MS computing device receives a score request including a merchant identifier associated with a candidate merchant, determines a geolocation and a merchant category associated with the candidate merchant based at least in part on the score request, and retrieves transaction data associated with transactions for a plurality of merchants including the candidate merchant and a set of peer merchants. Each peer merchant is associated with the geolocation and merchant category of the candidate merchant. The MS computing device further compares the transaction data associated with the candidate merchant to the transaction data associated with the peer merchants, generates a merchant lending score associated with the candidate merchant that indicates a relative performance level based on the comparison, and transmits the merchant lending score to a requestor computing device.

### BACKGROUND

The field of the present disclosure relates generally to generating lending scores for merchants, and more particularly, using transaction data associated with merchants to generate a unique lending score for each merchant.

Some merchants use business loans to fund relatively large expenditures for their businesses, such as start-up costs, equipment costs, and infrastructure costs. The merchants request business loans from banks or other financial institutions. In order to approve the merchants for the business loans, the banks typically try to determine whether or not the merchants are likely to repay the business loans. At least some known banks analyze a payment account of a requesting merchant at the bank to make the determination. The account is payable to the merchant such that payments owed by customers are received in the account and operating costs (e.g., rent, wages, equipment costs, etc.) of the merchant are paid using the payment account. For example, if the payment account of the merchant has an increasing monetary value, the bank may determine that the merchant is likely to repay the business loan and approves the merchant's request for the loan. Conversely, if the monetary value of the payment account is decreasing or is below a certain monetary value, the bank may determine the merchant is unlikely to repay the loan and therefore declines the merchant's request.

These known methods and systems for determining a merchant's ability to repay a business loan have a limited scope and do not account for details such as the merchant's popularity, the store location, the type of customers (e.g., repeat and new customers), and other transaction-related information. The limited scope of these known systems may cause the banks to decline merchants, particularly small merchants, that might otherwise have a relatively high chance of repaying the business loan.

Similarly, the limited scope may cause the banks to approve business loan requests to merchants that are unlikely to repay the business loan. For example, an unpopular merchant having a low transaction volume may not even remain in business for the entire duration of the business loan.

### BRIEF DESCRIPTION

In one aspect, a merchant score (MS) computing device for generating merchant lending scores for business loans is provided. The MS computing device includes a processor and a memory device in communication with the processor. The processor receives, from a requestor computing device, a score request including a merchant identifier associated with a candidate merchant, determines a geolocation and a merchant category associated with the candidate merchant based at least in part on the score request, and retrieves transaction data associated with transactions for a plurality of merchants including the candidate merchant and a set of peer merchants. Each merchant of the peer merchants is associated with the geolocation and merchant category of the candidate merchant. The processor further compares the transaction data associated with the candidate merchant to the transaction data associated with the set of peer merchants, generates a merchant lending score associated with the candidate merchant based on the comparison, and transmits the merchant lending score to the requestor computing device. The merchant lending score indicates a relative performance level of the candidate.

In another aspect, a method for generating a merchant lending score associated with a candidate merchant is provided. The method is at least partially performed by an MS computing device. The method includes receiving a score request from a requestor computing device, the score request including a merchant identifier associated with a candidate merchant, determining a geolocation and a merchant category associated with the candidate merchant based at least in part on the score request, and retrieving transaction data associated with transactions for a plurality of merchants including the candidate merchant and a set of peer merchants. Each merchant of the peer merchants is associated with the geolocation and merchant category of the candidate merchant. The method further includes comparing the transaction data associated with the candidate merchant to the transaction data associated with the set of peer merchants, generating a merchant lending score associated with the candidate merchant based on the comparison, and transmitting the merchant lending score to the requestor computing device. The merchant lending score indicates a relative performance level of the candidate merchant.

In yet another aspect, at least one non-transitory computer-readable storage media having computer-executable instructions embodied thereon is provided. When executed by at least one processor, the computer-executable instructions cause the processor to receive, from a requestor computing device, a score request including a merchant identifier associated with a candidate merchant, determine a geolocation and a merchant category associated with the candidate merchant based at least in part on the score request, and retrieve transaction data associated with transactions for a plurality of merchants including the candidate merchant and a set of peer merchants. Each merchant of the peer merchants is associated with the geolocation and merchant category of the candidate merchant. The computer-executable instructions further cause the processor to compare the transaction data associated with the candidate merchant to the transaction data associated with the set of peer merchants, generate a merchant lending score associated with the candidate merchant based on the comparison, and transmit the merchant lending score to the requestor computing device. The merchant lending score indicates a relative performance level of the candidate merchant.

### BRIEF DESCRIPTION OF THE DRAWINGS

FIGS. 1-9 show example embodiments of the methods and systems described herein.

FIG. 1 is a schematic diagram illustrating an example merchant score (MS) system for generating merchant lending scores in accordance with one embodiment of the present disclosure.

FIG. 2 is an example data flow diagram of the system shown in FIG. 1.

FIG. 3 is an example score table for a first candidate merchant that may be generated by the system shown in FIG. 1.

FIG. 4 is an example score table for a second candidate merchant that may be generated by the system shown in FIG. 1.

FIG. 5 is an example multi-party payment card processing system that may be used to provide transaction data to the system shown in FIG. 1.

FIG. 6 is an expanded block diagram of an example embodiment of a remote device for use in the system shown in FIG. 1.

FIG. 7 illustrates an example configuration of a host system for use in the system shown in FIG. 1.

FIG. 8 is a flowchart of an example process for providing a lending score to a merchant using the system shown in FIG. 1.

FIG. 9 is a diagram of components of one or more example computing devices that may be used in embodiments of the described systems and methods.

### DETAILED DESCRIPTION

Systems and method according to this disclosure are directed to a merchant score (MS) system having an MS computing device configured to generate lending scores for merchants based on transaction data. The lending scores are provided to one or more banks or other lending parties that analyze the lending scores to determine whether or not to provide business loans to merchants corresponding to the lending scores.

As used herein, a “business loan” is a monetary loan for a merchant. The business loan may be used at least partially to fund purchases associated with the merchant, such as start-up costs, equipment costs, and infrastructure costs. Although the systems and methods described herein provide lending scores for business loans, it is to be understood that other types of loans may be determined based on the lending scores described herein.

In the example embodiment, the MS computing device is communicatively coupled to one or more requestor computing devices and a transaction database. The requestor computing devices are associated with a lending party, such as a bank or other financial institutions. In some embodiments, the requestor computing devices may be associated with a third party other than the lending party. In certain embodiments, merchant computing devices associated with merchants may be communicatively coupled to the MS computing device.

The MS computing device is further communicatively coupled to a database for retrieving and storing data. In particular, the database may store transaction data, merchant data, and cardholder data. The transaction data is associated with a plurality of transactions and is collected during the processing of the transactions by a payment network. In the example embodiment, the transaction data is associated with payment accounts, payment cards (e.g., credit cards), and/or digital wallets. The transaction data may include, but is not limited to, a payment amount (also referred to as “ticket size”), an account identifier (e.g., a primary account number (PAN)), a cardholder identifier, a merchant identifier, and/or a timestamp associated with the transaction. The merchant data includes, for example, location identifiers and merchant categories associated with one or more merchants. The location identifier is a geographic region or geolocation that includes at least one merchant. The geolocation may be defined based on the location of a merchant or other predefined geographic regions. In one example, the geolocation is a neighborhood, town, city, zip code, state, country or other geographical region that includes the merchant. In another example, the geolocation is centered on the candidate merchant and extends a predetermined distance from the candidate merchant. The merchant categories identify merchants that sell similar products or services. For example, one merchant category may be a coffee shop and another category may be electronics store. In at least some embodiments, the merchant categories may also indicate a type of merchant, such as independent, chain store, and the like. The cardholder data includes cardholder tier information associated with the spending level of cardholders described in detail further herein.

The MS computing device is configured to provide a merchant lending score service. More specifically, the MS computing device retrieves transaction data from the payment network for a candidate merchant and the candidate merchant's peers, and classifies the transaction data into various tiers, level, and categories described herein. The merchant's peers are other merchants within the same geographic region or geolocation as the candidate merchant and the same or similar merchant category.

Lending parties and/or merchants may enroll in the merchant lending score service. In some embodiments, the lending parties and/or the merchants are automatically enrolled in the service. In certain embodiments, the lending parties and/or the merchants provide enrollment information to the MS computing device. In one example, a lending party enrolling in the score service provides a set of weighting factors to the MS computing device for the analysis described herein to facilitate a customized service for the lending party. In another example, a merchant may provide geolocation and/or merchant category information to the MS computing device during enrollment. The enrollment information may be updated after enrollment. In other embodiments, the lending parties and/or the merchants are automatically enrolled in the lending score service. In such embodiments, the MS computing device may be configured to enable the lending parties and/or the merchants to opt-out of the service.

Once enrolled, the lending parties use the merchant lending score service to provide enhanced information associated with a candidate merchant to determine whether or not to approve a business loan for the candidate merchant. In the example embodiment, the requestor computing device transmits a score request to the MS computing device. The score request includes a merchant identifier associated with a candidate merchant. The MS computing device receives the score request and determines a geolocation and a merchant category associated with the candidate merchant. In some embodiments, the score request includes a location identifier and/or a merchant category associated with the candidate merchant. In other embodiments, the MS computing device is configured to perform a lookup in the database for the geolocation and the merchant category of the candidate merchant using the merchant identifier.

In the example embodiment, the MS computing device is configured to retrieve transaction data associated with the candidate merchant and a set of peer merchants that have the same or similar geolocation and merchant category as the candidate merchant. The set of peer merchants may include one or more merchants. In at least some embodiments, the database and/or the MS computing device is in communication with a payment processor of the payment network to receive the transaction data. The payment network is a closed network (i.e., connection to the payment network requires permission from the administrator of the payment network). The payment network is configured to facilitate generating, receiving, and/or transmitting messages associated with transactions for one or more merchants, issuers, and acquirers in communication with the payment network. In particular, the payment network is configured to facilitate generating, receiving, and/or transmitting messages associated with payment card transactions. The messages are formatted according to specific protocols associated with the network and include extractable data elements that payment processor 108 is configured to analyze, extract, and classify to form the transaction data received by the MS computing device. In one example, at least a portion of the transaction data is extracted from authorization request messages from the payment network, such as ISO® 8583 compliant messages and ISO® 20022 compliant messages. As used herein, “ISO®” refers to a series of standards approved by the International Organization for Standardization (ISO is a registered trademark of the International Organization for Standardization of Geneva, Switzerland). ISO® 8583 compliant messages are defined by the ISO® 8583 standard which governs financial transaction card originated messages and further defines acceptable message types, data elements, and code values associated with such financial transaction card originated messages. ISO® 8583 compliant messages include a plurality of specified locations for data elements. ISO® 20022 compliant messages are defined by the ISO® 20022 standard. For example, ISO® 20022 compliant messages may include acceptor to issuer card messages (ATICA).

In the example embodiment, the MS computing device compares the transaction data associated with the candidate merchant to the transaction data of the peer merchants and generates a merchant lending score associated with the candidate merchant based on the comparison. More specifically, the MS computing device is configured to generate model transaction data that represents an average or other combination of the transaction data associated with the peer merchants and compare the transaction data associated with the candidate transaction to the model transaction data. The comparison indicates the performance and popularity of the candidate merchant relative to the peer merchants. If the candidate merchant has a better performance compared to the model of the peer merchants, then the candidate merchant is more likely to repay a business loan as compared to the peer merchants because the candidate merchant should generate sufficient business to afford loan payments for the duration of the loan. That is, the candidate merchant has the growth and current business relative to the peer merchants to repay the business loan. Conversely, if the candidate merchant has a lower performance than the model of the peer merchants, the candidate merchant may not be able to stay in business to repay the business loan.

In at least some embodiments, the MS computing device analyzes the transaction data and separates or classifies the transaction data into several levels, tiers, and categories. The separated transaction data may be stored separately or include identifiers that facilitate identifying and retrieving particular portions of the transaction data. Separating the transaction data enables the MS computing device to apply weighting factors to particular levels, tiers, or categories, thereby facilitating enhanced comparisons between a candidate merchant and the peer merchants, and facilitating generating a customized merchant lending score. The weighting factors may be predetermined by the lending party or the MS computing device. In the example embodiment, the transaction data is classified in a hierarchical configuration. That is, the transaction data is classified into a first set of levels that are further separated into dependent levels or tiers. The hierarchical configuration provides enhanced granularity to the transaction data such that certain transactions are emphasized comparative to other transactions within the transaction data. In other embodiments, the transaction data is classified in a different configuration.

In the example embodiment, the MS computing device classifies each transaction of the transaction data within a plurality of transaction levels. The transaction levels represent different ranges of ticket size (i.e., payment amount) of the transaction data. For example, for a coffee shop, the transaction levels may include a first transaction level for transactions below five dollars, a second transaction level for transactions between five and ten dollars, and a third transaction level for transactions above ten dollars. The MS computing device determines a transaction volume (i.e., a number of transactions) within each transaction level for the candidate merchant and each peer merchant. The transaction volumes of the peer merchants for each transaction level are averaged together to generate a model transaction volume.

The transaction volumes within the transaction levels are further classified into cardholder tiers. Cardholder tiers indicate a cardholder's spend level, which is determined by the cardholder's average ticket size, transaction frequency, income, average payment card bill, and/or other related factors. For example, cardholders that do not initiate many transactions and have a relatively low average ticket size may be in a cardholder tier different than the cardholder that initiates a relatively high number of transactions and has a relatively high average ticket size. In at least some embodiments, the cardholder tiers are stored in a predetermined cardholder tier table. More specifically, the cardholder tier table includes a plurality of entries. Each entry identifies a cardholder or a payment account of the cardholder and an associated cardholder tier. In the example embodiment, the cardholder tier table is stored in the database. In other embodiments, the cardholder tier table is stored in another suitable storage device in communication with the MS computing device. The MS computing device identifies a cardholder or payment account associated with each transaction of the transaction data. The MS computing device performs a look-up within the cardholder tier table for the identified cardholders or payment accounts of the cardholders to determine a cardholder tier associated with each cardholder.

The MS computing device classifies each transaction within a cardholder tier such that each cardholder tier has a corresponding transaction volume. The transaction volumes may be subsets of the transaction volumes determined for the transaction levels. Similar to the transaction levels, a candidate transaction volume associated with the candidate merchant and a model transaction volume representing an average transaction volume for the peer merchants is determined for each cardholder tier. In the example embodiment, classifying the transaction data within the cardholder tiers is done for each transaction level such that a single cardholder tier is divided between the transaction levels.

The MS computing device further classifies each transaction as associated with a new customer or a repeat customer for the merchant associated with the transaction. That is, if a prior transaction between the cardholder or the payment account of the cardholder and the merchant is not identified, the cardholder is a new customer. Conversely, if a prior transaction between the cardholder and the merchant is identified, the cardholder is a repeat customer. The MS computing device determines a candidate transaction volume and a model transaction volume for new and repeat customers. In the example embodiment, the transaction volumes for new and repeat customers are divided for each cardholder tier and transaction level.

Once the candidate and model transaction volumes are determined for each transaction level, cardholder tier, and customer category (i.e., new or repeat customer), the candidate and model transaction volumes are compared and the weighting factors are applied. In the example embodiment, the candidate transaction volumes are divided by the respective model transaction volumes and multiplied by a respective weighting factor to generate a plurality of volume scores. The volume scores indicate the candidate merchant's performance relative to the model for a particular subset of the transaction data. The generated volume scores are then combined together to generate the merchant lending score.

The MS computing device is configured to transmit the merchant lending score to the requestor computing device associated with the score request for analysis. In at least some embodiments, the MS computing device may also transmit the volume scores and/or a score table to the requestor computing device. The score table provides the lending party additional detail about the metrics of the candidate merchant and its peers as well as the process performed by the MS computing device to generate the merchant lending score. In particular, the score table includes the candidate and model transaction volumes for each level, tier, and category, the corresponding weighting factors, the volume scores, and the merchant lending score. In the example embodiment, the MS computing device is configured to transmit the merchant lending score to the requestor computing device in substantially real-time. That is, when the requestor computing device transmits the score request to the MS computing device, the MS computing device provides the merchant lending score in near real-time (e.g., less than thirty seconds).

In some embodiments, the MS computing device is configured to generate a recommendation to approve or decline a loan request associated with the candidate merchant. In particular, the MS computing device stores one or more predetermined thresholds. The predetermined thresholds may be determined based on the geolocation and/or the merchant category of the candidate merchant. The merchant lending score is compared to the thresholds to generate the recommendation. In one example, the merchant lending score is compared to one threshold and, based on the comparison, the MS computing device generates a recommendation to approve or decline a loan request for the candidate merchant. The recommendation is transmitted to the requestor computing device with the merchant lending score to facilitate analysis as described herein.

Once the requestor computing device receives the merchant lending score and any other data from the MS computing device, the lending party analyzes the merchant lending score to determine whether or not to approve or decline a business loan request from the candidate merchant. For example, if the candidate merchant has a relatively good merchant lending score that indicates the candidate merchant performs better than average with respect to its peer merchants, the lending party may approve the business loan. In some embodiments, the requestor computing device is configured to automatically determine whether or not to approve or decline a business loan request based on the merchant lending score. More specifically, the requestor computing device stores rules or a set of instructions in an associated memory that are automatically applied to the received merchant lending score to make the determination. In other embodiments, the requestor computing device automatically approves or declines the candidate merchant for a loan based on the recommendation generated by the MS computing device.

The methods and systems described herein may be implemented using computer programming or engineering techniques including computer software, firmware, hardware or any combination or subset thereof, wherein the technical effects may be achieved by performing one of the following steps: (i) receiving, from a requestor computing device, a score request including a merchant identifier associated with a candidate merchant; (ii) determining a geolocation and a merchant category associated with the candidate merchant based at least in part on the score request; (iii) retrieving transaction data associated with transactions for a plurality of merchants including the candidate merchant and a set of peer merchants, each merchant of the peer merchants associated with the determined geolocation and merchant category of the candidate merchant; (iv) classifying the transaction data of the candidate merchant and the peer merchants into one or more levels, tiers, and categories; (v) determining at least one candidate transaction volume and at least one model transaction volume for each level, tier, and category; (vi) applying weighting factors to the candidate transaction volumes; (vii) comparing the weighed candidate transaction volumes with respective model transaction volumes; (viii) generating a plurality of volume scores based on the comparisons; (ix) generating a merchant lending score associated with the candidate merchant at least partially as a function of the volume scores; and (x) transmitting the merchant lending score to the requestor computing device, wherein a lending party associated with the requestor computing device approves or declines the candidate merchant for a business loan based at least in part on the transmitted merchant lending score.

The systems and methods described herein are configured to facilitate (a) enhanced information for business loan approvals; (b) improved processing speeds by providing the merchant lending scores in substantially real-time; (c) reduced processing, bandwidth, and storage requirements for the requestor computing devices to analyze a candidate merchant by performing the service at the MS computing device; (d) improved granularity of the analysis for the candidate merchant by classifying and weighting the transaction data; (e) improved customization of the lending scores by providing customizable weighting factors; and (f) improved searching and retrieval of transaction data by storing and classifying the transaction data according to specific protocols.

Described herein are computer systems such as a payment processor, a requestor computing device, and an MS computing device. As described herein, all such computer systems include a processor and a memory.

Further, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

The systems and processes are not limited to the specific embodiments described herein. In addition, components of each system and each process can be practiced independent and separate from other components and processes described herein. Each component and process also can be used in combination with other assembly packages and processes.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of transaction card can be used as a method of payment for performing a transaction.

The following detailed description illustrates embodiments of the disclosure by way of example and not by way of limitation. It is contemplated that the disclosure has general application to provide cardholder information to account-on-file merchants.

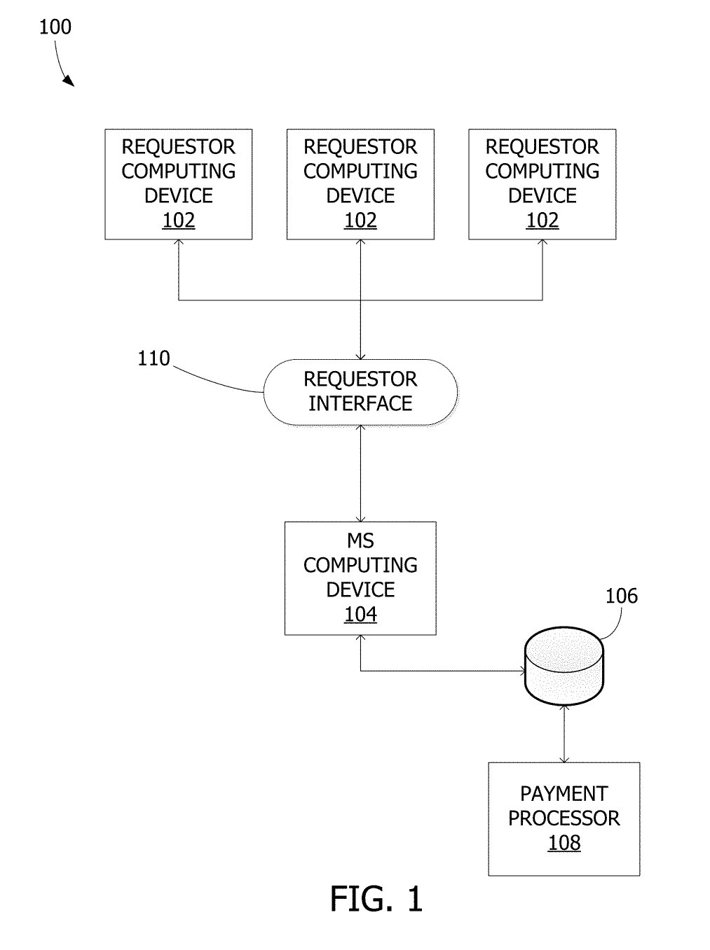

FIG. 1 is a schematic diagram illustrating an example merchant score (MS) system 100 for providing merchant lending scores to lending parties. In the example embodiment, system 100 includes a plurality of requestor computing devices 102, an MS computing device 104, and a transaction database 106. Transaction database 106 is communicatively coupled to a payment processor 108 of an example payment network (not shown in FIG. 1). In other embodiments, system 100 may include additional, fewer, or alternative subsystems, including those described elsewhere herein.

Each requestor computing device 102 is associated with a lending party (e.g., a bank) or a different third party. Requestor computing devices 102 are communicatively coupled to MS computing device 104 via a requestor interface 110. Requestor interface 110 may be an application program interface (API), a web interface, and/or a different interface that enable requestor computing devices 102 to communicate with MS computing device 104. In some embodiments, a merchant computing device (not shown) is communicatively coupled to MS computing device 104 to receive a merchant lending score as described herein.

MS computing device 104 is configured to provide a merchant lending score service to the lending parties of requestor computing devices 102. In particular, MS computing device 104 is configured to receive a score request from requestor computing device 102 that identifies a candidate merchant and transmit a merchant lending score associated with the candidate merchant in response to the requesting requestor computing device 102. In at least some embodiments, the merchant lending score is transmitted in near real-time to requestor computing device 102. The merchant lending score is generated based on transaction data associated with the candidate merchant and other merchants as describe herein.

Lending parties and/or merchants may enroll in the merchant lending score service. In some embodiments, the lending parties and/or the merchants are automatically enrolled in the service. In such embodiments, the MS computing device may be configured to enable the lending parties and/or the merchants to opt-out of the service. In certain embodiments, the lending parties and/or the merchants provide enrollment information to MS computing device 104 that facilitates the merchant lending score. The enrollment information may be updated after enrollment. Once enrolled, the lending parties use the merchant lending score service to receive enhanced information associated with a candidate merchant to determine whether or not to approve a business loan for the candidate merchant.

Transaction database 106 is communicatively coupled to MS computing device 104. In other embodiments, transaction database 106 is integrated with MS computing device 104 or payment processor 108. Transaction database 106 is configured to receive, store, and transmit data for the merchant lending score service. In particular, database 106 may store transaction data, merchant data, and cardholder data. The transaction data is associated with a plurality of transactions and is collected during the processing of the transactions by a payment network. In the example embodiment, the transaction data is associated with payment accounts, payment cards (e.g., credit cards), and/or digital wallets. The transaction data may include, but is not limited to, a payment amount (also referred to as “ticket size”), an account identifier (e.g., a primary account number (PAN)), a cardholder identifier, a merchant identifier, and/or a timestamp associated with the transaction. The merchant data includes, for example, location identifiers and merchant categories associated with one or more merchants. The location identifier is a geographic region or geolocation that includes at least one merchant. The geolocation may be defined based on the location of a merchant or other predefined geographic regions. In one example, the geolocation is a neighborhood, town, city, zip code, state, country or other geographical region that includes the merchant. In another example, the geolocation is centered on the candidate merchant and extends a predetermined distance from the candidate merchant. The merchant categories identify merchants that sell similar products or services. For example, one merchant category may be a coffee shop and another category may be electronics store. In at least some embodiments, the merchant categories may also indicate a type of merchant, such as independent, chain store, and the like. Each merchant may be associated with one or more merchant categories. The cardholder data includes cardholder tier information associated with the spending level of cardholders described in detail further herein.

In the example embodiment, database 106 receives the transaction data from payment processor 108 of the payment network. The payment network is a closed network (i.e., connection to the payment network requires permission from the administrator of the payment network). The payment network is configured to facilitate generating, receiving, and/or transmitting messages associated with transactions for one or more merchants, issuers, and acquirers in communication with the payment network. In particular, the payment network is configured to facilitate generating, receiving, and/or transmitting messages associated with payment card transactions. The messages are formatted according to specific protocols associated with the network and include extractable data elements that payment processor 108 is configured to analyze, extract, and classify to form the transaction data received by MS computing device 104. In one example, at least a portion of the transaction data is extracted from authorization request messages from the payment network, such as ISO® 8583 compliant messages and ISO® 20022 compliant messages. The merchant data and/or the cardholder data may also be retrieved from payment processor 108. Alternatively, a different computing device provides the merchant data and/or cardholder data to database 106. In one example, the enrollment information provided during enrollment for the merchant lending score service may be stored as merchant data.

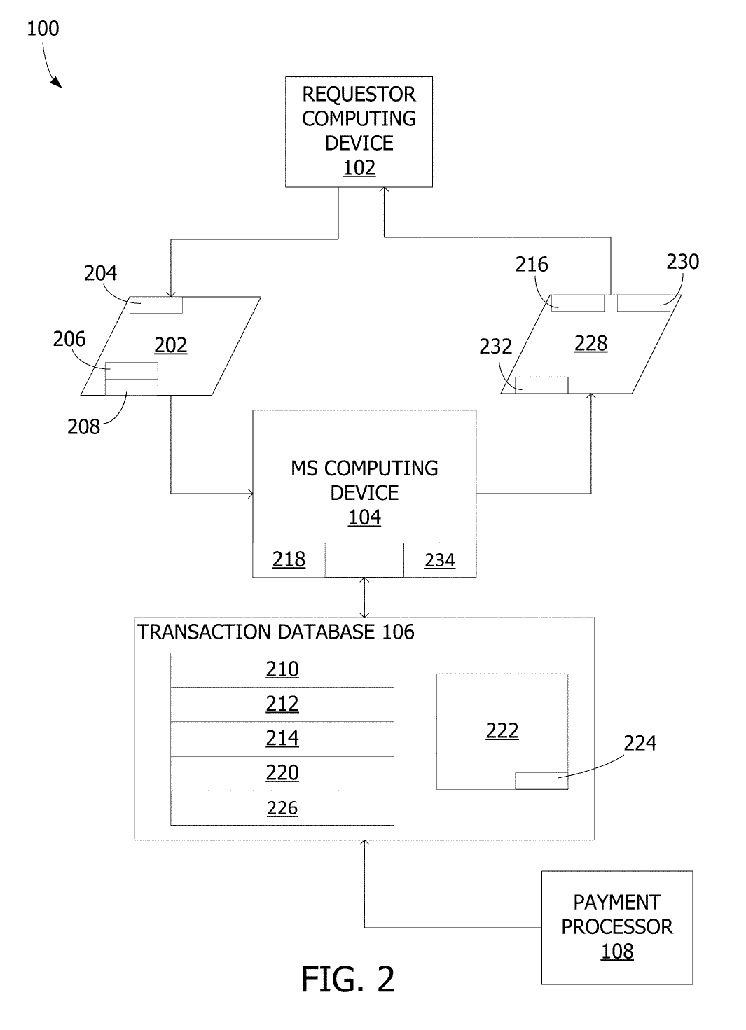

FIG. 2 is an example data flow diagram of system 100 shown in FIG. 1. In particular, FIG. 2 depicts the data flow between requestor computing device 102, MS computing device 104, transaction database 106, and payment processor 108. In other embodiments, system 100 may provide additional, fewer, or alternative data, including those described elsewhere herein.

With respect to FIGS. 1 and 2, in the example embodiment, requestor computing device 102 transmits a score request 202 to MS computing device 104. Score request 202 includes a merchant identifier 204 associated with a candidate merchant. MS computing device 104 receives score request 202 and determines a geolocation and a merchant category associated with the candidate merchant. In at least some embodiments, score request 202 includes a location identifier 206 and/or a merchant category 208 associated with the candidate merchant. In other embodiments, MS computing device 104 is configured to perform a lookup in database 106 for the geolocation and the merchant category of the candidate merchant using merchant identifier 204. More specifically, MS computing device 104 performs a lookup of merchant data 210 stored within database 106 using merchant identifier 204. Merchant data 210 includes information associated with a plurality of merchants, including, but not limited to, merchant categories, merchant identifiers, and geolocations of merchants.

In the example embodiment, MS computing device 104 is configured to retrieve candidate transaction data 212 associated with the candidate merchant and peer transaction data 214 associated with a set of peer merchants that have the same or similar geolocation and merchant category as the candidate merchant. The set of peer merchants may include one or more merchants. In the example embodiment, transaction data 212, 214 are received by database 106 from payment processor 108.

In the example embodiment, MS computing device 104 compares candidate transaction data 212 to peer transaction data 214 and generates a merchant lending score 216 associated with the candidate merchant based on the comparison. More specifically, MS computing device 104 is configured to generate model transaction data 218 that represents an average or other combination of peer transaction data 214 for every peer merchant and compare candidate transaction data 212 to model transaction data 218. The comparison indicates the performance and popularity of the candidate merchant relative to the peer merchants. If the candidate merchant has a better performance compared to the model of the peer merchants, the candidate merchant may be relatively likely to repay a business loan because the candidate merchant is generating sufficient business to afford repayment terms for the duration of the loan. That is, the candidate merchant has the growth and current business relative the peer merchants to repay a business loan. Conversely, if the candidate merchant has a lower performance than the model of the peer merchants, the candidate merchant may not be able to stay in business or be able to afford to repay the business loan.

In at least some embodiments, MS computing device 104 analyzes transaction data 212, 218 and separates or classifies transaction data 212, 218 into several levels, tiers, and categories. The each classified group of transaction data 212, 218 may be stored separately or include identifiers that facilitate identifying and retrieving particular portions of transaction data 212, 218. Separating transaction data 212, 218 enables MS computing device 104 to apply weighting factors 220 to particular levels, tiers, or categories, thereby facilitating enhanced comparisons between a candidate merchant and the peer merchants. Weighting factors 220 may be predetermined by the lending party or MS computing device 104. In the example embodiment, transaction data 212, 218 are classified in a hierarchical configuration. That is, transaction data 212, 218 are classified into a first set of levels that are further separated into dependent levels or tiers. The hierarchical configuration provides enhanced granularity to analysis of transaction data 212, 218 and the candidate merchant such that certain transactions are emphasized comparative to other transactions within transaction data 212, 218. In other embodiments, transaction data 212, 218 is classified in a different configuration.

In the example embodiment, MS computing device 104 classifies each transaction of transaction data 212, 218 within a plurality of transaction levels. The transaction levels represent different ranges of ticket size (i.e., payment amount) of the transaction data. The MS computing device determines a transaction volume (i.e., a number of transactions) within each transaction level for both candidate transaction data 212 and model transaction data 218.

The transaction volumes within the transaction levels are further classified into cardholder tiers. Cardholder tiers indicate a cardholder's spend level, which is determined by the cardholder's average ticket size, transaction frequency, income, average payment card bill, and/or other related factors. For example, cardholders that do not initiate many transactions and have a relatively low average ticket size may be in a cardholder tier different than the cardholder that initiates a relatively high number of transactions and has a relatively high average ticket size. In at least some embodiments, the cardholder tiers are stored in a predetermined cardholder tier table 222. More specifically, cardholder tier table 222 includes a plurality of entries 224. Each entry identifies a cardholder or a payment account of the cardholder and an associated cardholder tier. In the example embodiment, cardholder tier table 222 is stored in database 106. In other embodiments, cardholder tier table 222 is stored in another suitable storage device in communication with MS computing device 104. MS computing device 104 is configured to identify a cardholder or payment account associated with each transaction of the transaction data. The MS computing device performs a look-up within cardholder tier table 222 for the identified cardholders or payment accounts of the cardholders to determine the cardholder tier of each cardholder.

MS computing device 104 classifies each transaction within a cardholder tier such that each cardholder tier has a corresponding transaction volume. The transaction volumes may be subsets of the transaction volumes determined for the transaction levels. Similar to the transaction levels, a candidate transaction volume associated with the candidate merchant and a model transaction volume representing an average transaction volume for the peer merchants is determined for each cardholder tier. In the example embodiment, classifying transaction data 212, 218 within the cardholder tiers is done for each transaction level such that a single cardholder tier is divided between the transaction levels.

MS computing device 104 further classifies each transaction of transaction data 212, 218 as associated with a new customer or a repeat customer for the merchant associated with the transaction. That is, if a prior transaction between a cardholder associated with the transaction or a payment account of the cardholder and the merchant is not identified, the cardholder is a new customer. Conversely, if a prior transaction between the cardholder and the merchant is identified, the cardholder is a repeat customer. MS computing device 104 determines a candidate transaction volume and a model transaction volume for new and repeat customers. In the example embodiment, the transaction volumes for new and repeat customers are divided for each cardholder tier and transaction level.

In some embodiments, MS computing device 104 is configured to classify repeat customers of transaction data 212, 218 into transaction frequency tiers. The transaction frequency tiers indicate how often a repeat customer makes a purchase at a merchant within a predetermined period of time (e.g., one month). The transaction frequency tiers may be dependent upon the geolocation and/or merchant category of the candidate merchant. In one example, the transaction frequency tiers include, in order of lowest to highest frequency, a “satisfied” tier, a “habit” tier, a “preference” tier, and a “loyal customer” tier. MS computing device 104 is configured to determine candidate transaction volumes and model transaction volumes for transaction data 212, 218, respectively, within the transaction frequency tiers.

In some embodiments, transaction data 212, 218 is classified in a different configuration. In one example, transaction data 212, 218 is first classified by cardholder tier, then transaction level, and then new or repeat customers. In another example, transaction data 212, 218 is classified by transaction level and local or visiting customers (i.e., local customers are cardholders that reside within the geolocation of the candidate merchant). In certain embodiments, transaction data 212, 218 is not classified in a hierarchical configuration, but rather a parallel configuration.

Once the candidate and model transaction volumes are determined for each transaction level, cardholder tier, and customer category (i.e., new or repeat customer), the candidate transaction volumes of candidate transaction data 212 and the model transaction volumes of model transaction data 218 are compared and weighting factors 220 are applied. In the example embodiment, each candidate transaction volume is divided by a respective model transaction volume and multiplied by a respective weighting factor to generate a plurality of volume scores 226. Volume scores 226 indicate the candidate merchant's performance relative to the model for a particular subset of candidate transaction data 212. The generated volume scores 226 are then combined together to generate merchant lending score 216.

MS computing device 104 is configured to transmit merchant lending score 216 to requestor computing device 102 associated with score request 202 for analysis. In the example embodiment, MS computing device 104 generates a request response 228 that includes merchant lending score 216 and transmits request response 228 to requestor computing device 102. In at least some embodiments, request response 228 may further include volume scores 226 and/or a score table 230 to requestor computing device 102. Score table 230 provides the lending party additional detail about the metrics of the candidate merchant and its peers as well as the process performed by MS computing device 104 to generate merchant lending score 216. In particular, score table 230 includes the candidate and model transaction volumes for each level, tier, and category, the corresponding weighting factors 220, volume scores 226, and merchant lending score 216. In the example embodiment, MS computing device 104 is configured to transmit request response 228 to requestor computing device 102 in substantially real-time. That is, when requestor computing device 102 transmits score request 202 to MS computing device 104, MS computing device 104 provides merchant lending score 216 in near real-time (e.g., within thirty seconds).

In at least some embodiments, MS computing device 104 is configured to generate a recommendation 232 to approve or decline a loan request associated with the candidate merchant. In particular, the MS computing device stores one or more predetermined thresholds 234. Predetermined thresholds 234 may be determined based on the geolocation and/or the merchant category of the candidate merchant. Merchant lending score 216 is compared to thresholds 234 to generate recommendation 232. In one example, merchant lending score 216 is compared to one threshold 234 and, based on the comparison, MS computing device 104 generates a recommendation 232 to approve or decline the candidate merchant for a loan request. Recommendation 232 is transmitted to requestor computing device 102 with the merchant lending score 216 to facilitate analysis as described herein.

After requestor computing device 102 receives merchant lending score 216 and any other data from MS computing device 104, the lending party analyzes merchant lending score 216 to determine whether or not to approve or decline a business loan request from the candidate merchant. For example, if the candidate merchant has a relatively good merchant lending score that indicates the candidate merchant performs better than average with respect to its peer merchants, the lending party may approve the business loan. In certain embodiments, requestor computing device 102 automatically approves or declines the candidate merchant for a business loan based on merchant lending score 216 and/or recommendation 232. That is, requestor computing device 102 may store a set of instructions or rules for automatically approving or declining business loans based on data received from MS computing device 104.

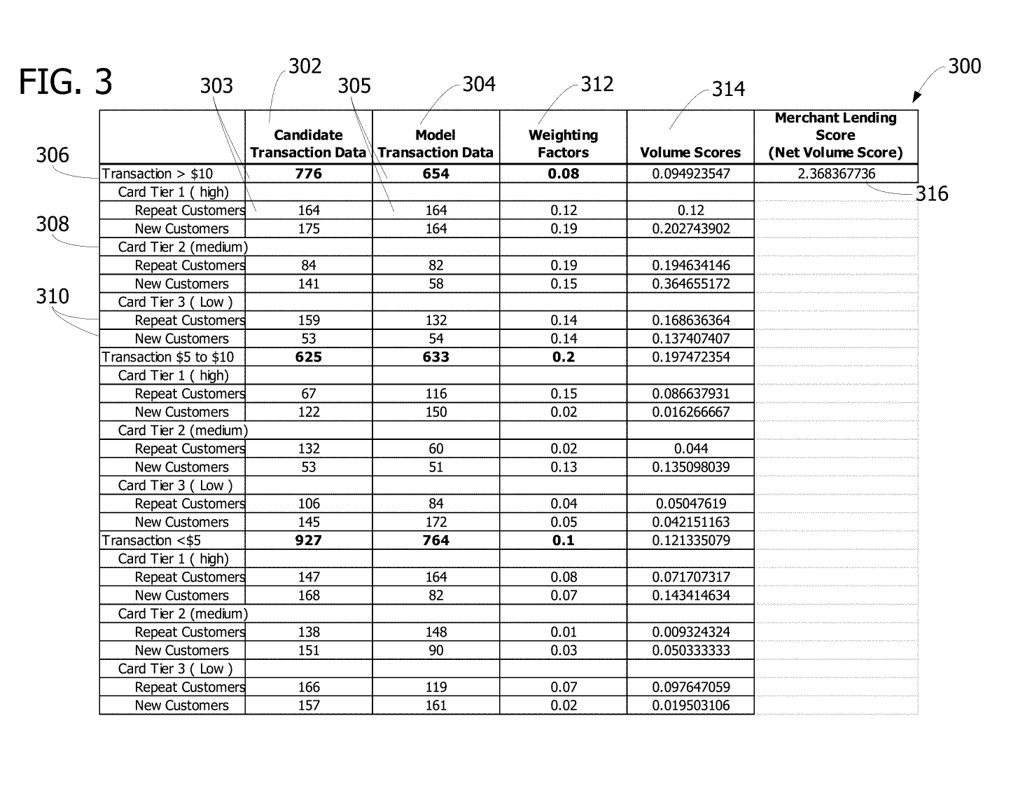

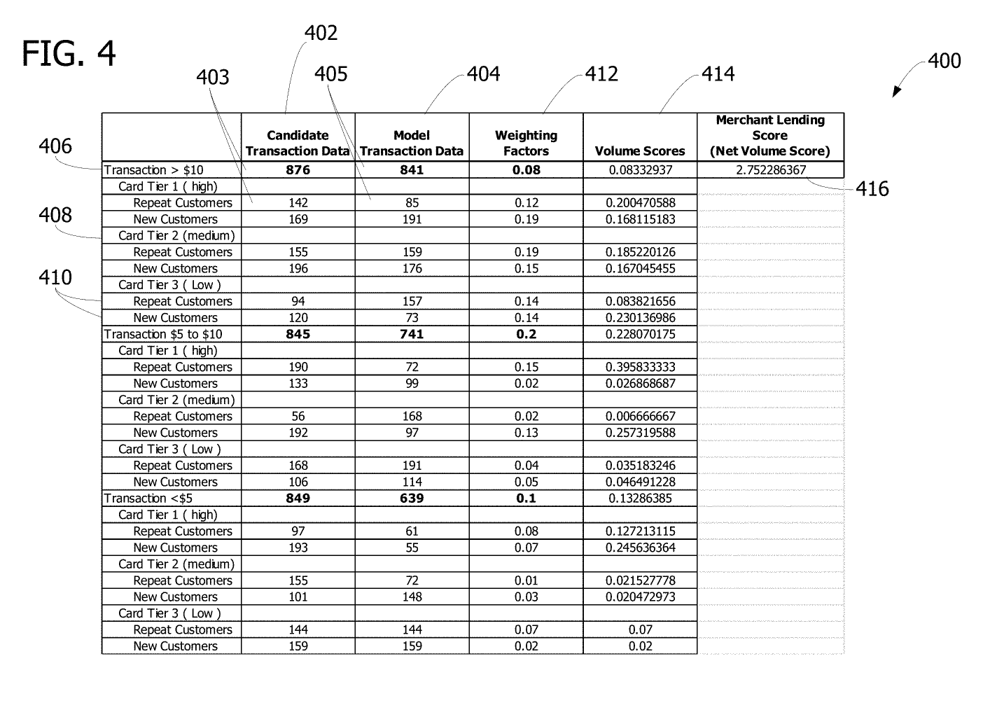

FIGS. 3 and 4 are example score tables 300, 400 for two example score requests that are generated by a merchant score system, such as system 100 (shown in FIG. 1). In particular, table 300 is associated with a first candidate merchant and table 400 is associated with a second candidate merchant. In the example embodiment, the first and second candidate merchants are independent coffee shops requesting a business loan. The first candidate merchant is located in Midtown of New York City, N.Y. and the second candidate merchant is located in Hoboken, N.J. In other embodiments, score tables 300, 400 include additional, fewer, or alternative data, including data described elsewhere herein.

With respect to FIG. 3, table 300 includes candidate transaction data 302 and model transaction data 304. Candidate transaction data 302 is transaction data for a plurality of transactions associated with the first candidate merchant. Model transaction data 304 is the averaged transaction data for a plurality of transactions associated with peer merchants of the first candidate merchant. In the example embodiment, the peer merchants are independent coffee shops in Midtown of New York City, N.Y. Transaction data 302, 304 include a plurality of transaction volumes 303, 305 (i.e., a number of transactions). Each transaction volume 303, 305 corresponds to a particular level, tier, and/or category.

In the example embodiment, candidate transaction data 302 and model transaction data 304 are classified into a plurality of transaction levels 306. Each transaction level 306 is associated with a ticket size range. For example, table 300 is divided into three transaction levels 306: a first transaction level 306 for transactions above ten dollars, a second transaction level 306 for transactions between five and ten dollars, and a third transaction level 306 for transactions below five dollars. In other embodiments, table 300 may include a different number of transaction levels 306 and/or a different ticket size range for each transaction level 306. Alternatively, transaction level 306 may be associated with a different transaction-related data element. Transaction data 302, 304 are divided between each transaction level 306 such that each level 306 has corresponding candidate and model transaction volumes 303, 305.

In the example embodiment, candidate transaction data 302 and model transaction data 304 are further classified into cardholder tiers 308. That is, for each transaction, a cardholder tier is determined and transaction data 302, 304 are classified based on cardholder tier 308. In the example embodiment, “Card Tier 1” represents a cardholder tier 308 that has a relative high spend level, “Card Tier 2” represents a cardholder tier 308 with a spend level less than Card Tier 1, and “Card Tier 3” represents a cardholder tier 308 with a spend level less than Card Tier 2. In other embodiments, additional or fewer cardholder tiers 308 may be used. Candidate transaction data 302 and model transaction data 304 are classified by cardholder tiers 308 as a subset of transaction levels 306. That is, for each transaction level 306, transaction volumes 303, 305 are further separated based on cardholder tiers 308.

Candidate transaction data 302 and model transaction data 304 are further classified based on customer category 310. Customer category 310 includes new customers or repeat customers. Each transaction is analyzed to determine whether or not the customer has previously performed a transaction with the merchant associated with the analyzed transaction. If the customer has a prior transaction, the customer is a repeat customer. Otherwise, the customer is a new customer. Transaction volumes 303, 305 are determined for each transaction level 306, cardholder tier 308, and customer category 310 combination. That is, in the example embodiment, transaction volumes 303, 305 of cardholder tiers 308 and customer categories 310 are subsets of transaction volumes 303, 305 associated with transaction levels 306. In other embodiments, a different configuration is used to determine transaction volumes 303, 305.

Table 300 further includes a plurality of weighting factors 312. Each weighting factor 312 is associated with a respective pair of transaction volumes 303, 305. Weighting factors 312 are configured to emphasize particular transactions and deemphasize other transactions. For example, in table 300, a weighting factor 312 of 0.19 is assigned to transactions above ten dollars for new, Card Tier 1 customers and a weighting factor of 0.02 is assigned to transactions between five and ten dollars for repeat, Card Tier 2 customers. Accordingly, the weighting factors 312 emphasize the impact of transaction above ten dollars for new, Card Tier 1 customers in comparison to transactions between five and ten dollars for repeat, Card Tier 2 customers. In at least some embodiments, the lending party may customize weighting factors 312 to facilitate a customized score.

Table 300 further includes a plurality of volume scores 314. Volume scores 314 are a result of comparing candidate transaction volumes 303 to model transaction volumes 305 within table 300 and applying weighting factors 312. In the example embodiment, each candidate transaction volume 303 is divided by a respective model transaction volume 305 and multiplied by a respective weighting factor 312 to generate volume scores 314. Volume scores 314 are then combined together to generate a composite merchant lending score 316 that represents the candidate merchant's performance relative to its peers and a confidence level that the candidate merchant can repay a business loan. In some embodiments, additional weighting factors (not shown) are applied to volume scores 314 to adjust merchant lending score 316. In the example embodiment, the first candidate merchant received a merchant lending score 316 of approximately 2.368.

With respect to FIG. 4, table 400 is substantially similar to table 300. In the absence of contrary representation, table 400 includes similar structure as table 300. In the example embodiment, table 400 includes candidate transaction data 402 associated with the second candidate merchant, a plurality of candidate transaction volumes 403, model transaction data 404, a plurality of model transaction volumes 405, a plurality of transaction levels 406, a plurality of cardholder tiers 408, a plurality of customer categories 410, a plurality of weighting factors 412, a plurality of volume scores 414, and a merchant lending score 416. Similar to the first candidate merchant, the peers of the second candidate merchant are independent coffee shops. However, unlike the first candidate merchant, the peers of the second candidate merchant are located in Hoboken, N.J. Accordingly, model transaction data 404 is associated with independent coffee shops in Hoboken, N.J. other than the second candidate merchant.

In the example embodiment, merchant lending score 416 of the second candidate merchant is approximately 2.752, which is greater than merchant lending score 316 of the first candidate merchant and therefore indicates the second candidate merchant performs better relative to its peers than in comparison to the first candidate merchant relative to its peers. That is, the process performed to generate merchant lending scores 316, 416 facilitate normalizing the performance of merchants in different locations and merchant categories, thereby enabling a lending party to analyze unrelated merchants using the same scoring scale.

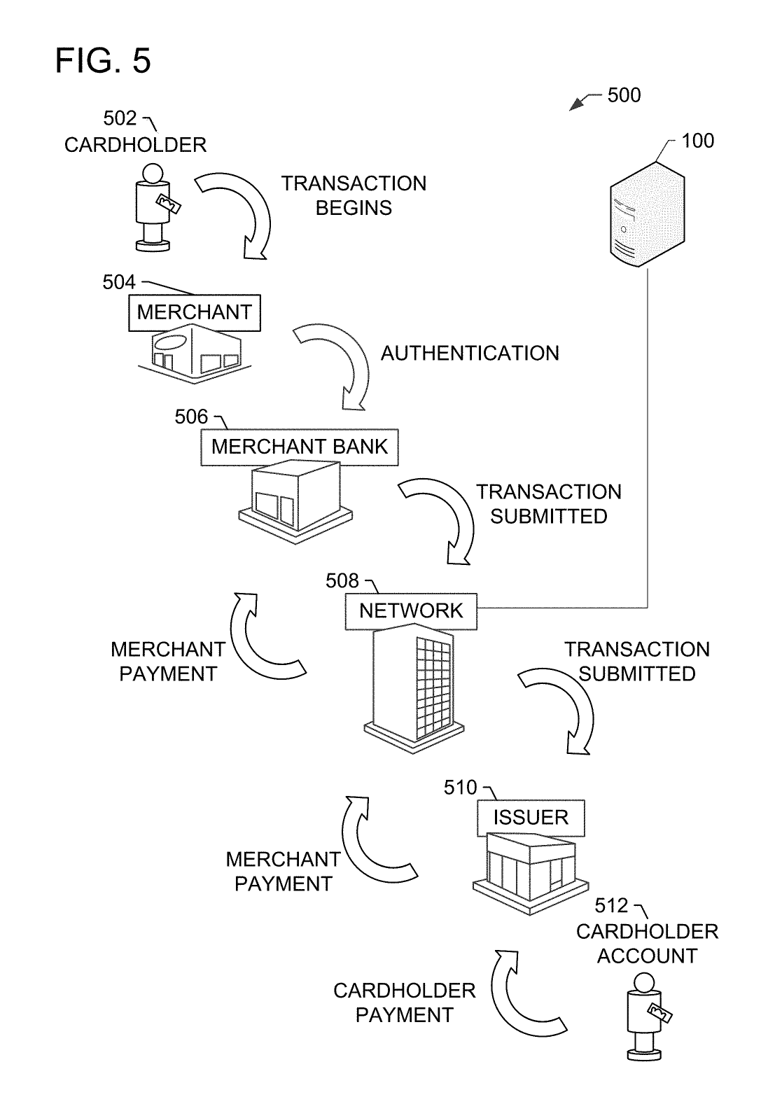

FIG. 5 is a schematic diagram illustrating an example multi-party payment card system 500 for processing payment card transactions. System 500 is communicatively coupled to MS system 100 (shown in FIG. 1) to provide transaction data, such as authorization messages, to system 100. The present disclosure relates to payment card system 500, such as a credit card payment system using the MasterCard® payment card system payment network 508 (also referred to as an “interchange” or “interchange network”). MasterCard® payment card system payment network 508 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.). In the example embodiment, payment processor 108 (shown in FIG. 1) is part of payment network 508.

In payment card system 500, a financial institution such as an issuer 510 issues a payment card for an account, such as a credit card account or a debit card account, to a cardholder 502, who uses the payment card to tender payment for a purchase from a merchant 504. To accept payment with the payment card, merchant 504 must normally establish an account with a financial institution that is part of the financial payment system. This financial institution is usually called the “merchant bank” or the “acquiring bank” or “acquirer bank” or simply “acquirer.” When a cardholder 502 tenders payment for a purchase with a payment card (also known as a financial transaction card), merchant 504 requests authorization from acquirer 506 for the amount of the purchase. Such a request is referred to herein as an authorization request message. The request may be performed over the telephone, but is usually performed through the use of a point-of-interaction terminal, also referred to herein as a point-of-sale device, which reads the cardholder's account information from the magnetic stripe on the payment card and communicates electronically with the transaction processing computers of acquirer 506. Alternatively, acquirer 506 may authorize a third party to perform transaction processing on its behalf. In this case, the point-of-interaction terminal will be configured to communicate with the third party. Such a third party is usually called a “merchant processor” or an “acquiring processor.”

For card-not-present (CNP) transactions, cardholder 502 provides payment information or billing data associated with the payment card electronically to merchant 504. The payment information received by merchant 504 is stored and transmitted to acquirer 506 and/or payment network 508 as part of an authorization request message. In some embodiments, merchant 504 transmits a plurality of authorization request messages together as a “batch” file to acquirer 506 and/or payment network 508.

Using payment card system payment network 508, the computers of acquirer 506 or the merchant processor will communicate with the computers of issuer 510, to determine whether the cardholder's account 512 is in good standing and whether the purchase is covered by the cardholder's available credit line or account balance. Based on these determinations, the request for authorization will be declined or accepted. If the request is accepted, an authorization code is issued to merchant 504.

When a request for authorization is accepted, the available credit line or available balance of cardholder's account 512 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 504 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For debit card transactions, when a request for authorization is approved by the issuer, cardholder's account 512 is decreased. Normally, a charge is posted immediately to cardholder's account 512. The bankcard association then transmits the approval to the acquiring processor for distribution of goods/services, or information or cash in the case of an ATM.

After a transaction is captured, the transaction is settled between merchant 504, acquirer 506, and issuer 510. Settlement refers to the transfer of financial data or funds between the merchant's account, acquirer 506, and issuer 510 related to the transaction. Usually, transactions are captured and accumulated into a “batch,” which is settled as a group.

In the example embodiment, payment network 508 is configured to transmit transaction data to MS system 100 to facilitate generating merchant lending scores based on the transaction data. In some embodiments, MS system 100 requests or retrieves the transaction data. In other embodiments, payment network 508 transmits the transaction data automatically to MS system 100. In certain embodiments, the transaction data may be transmitted to MS system 100 from another source, such as issuer 510.

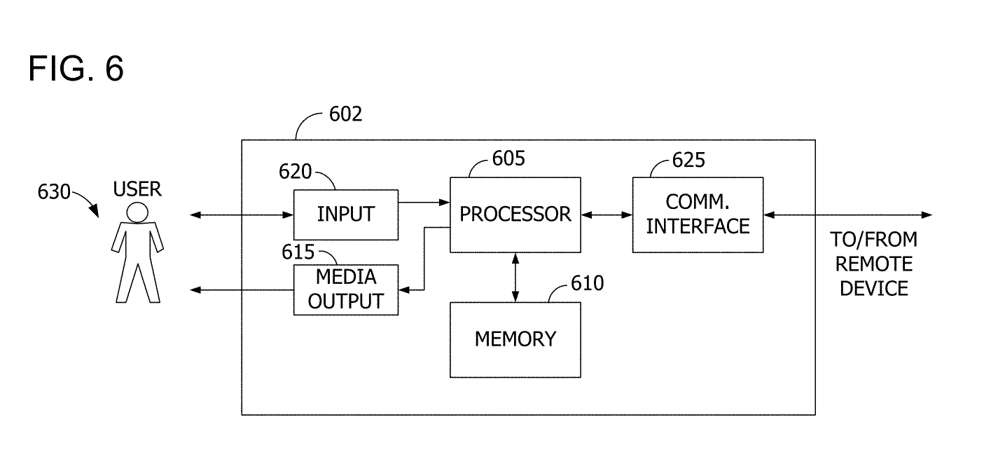

FIG. 6 depicts an exemplary configuration of a remote or user computing device 602, such as requestor computing device 102 (shown in FIG. 1). Computing device 602 may include a processor 605 for executing instructions. In some embodiments, executable instructions may be stored in a memory area 610. Processor 605 may include one or more processing units (e.g., in a multi-core configuration). Memory area 610 may be any device allowing information such as executable instructions and/or other data to be stored and retrieved. Memory area 610 may include one or more computer-readable media.

Computing device 602 may also include at least one media output component 615 for presenting information to a user 630. Media output component 615 may be any component capable of conveying information to user 630. In some embodiments, media output component 615 may include an output adapter, such as a video adapter and/or an audio adapter. An output adapter may be operatively coupled to processor 605 and operatively coupleable to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, media output component 615 may be configured to present an interactive user interface (e.g., a web browser or client application) to user 630.

In some embodiments, computing device 602 may include an input device 620 for receiving input from user 630. Input device 620 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 615 and input device 620.

Computing device 602 may also include a communication interface 625, which may be communicatively coupleable to a remote device. Communication interface 625 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 610 are, for example, computer-readable instructions for providing a user interface to user 630 via media output component 615 and, optionally, receiving and processing input from input device 620. A user interface may include, among other possibilities, a web browser and client application. Web browsers enable users 630 to display and interact with media and other information typically embedded on a web page or a website from a web server associated with a merchant. A client application allows users 630 to interact with a server application associated with, for example, a vendor or business.

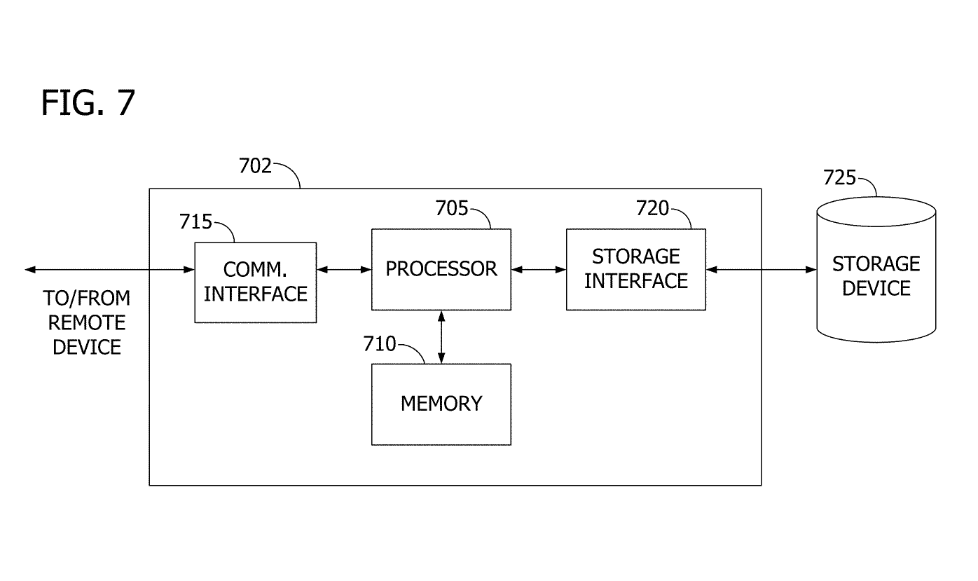

FIG. 7 depicts an exemplary configuration of a host computing device 702, such as MS computing device 104 and payment processor 108 (shown in FIG. 1). Host computing device 702 may include a processor 705 for executing instructions. Instructions may be stored in a memory area 710, for example. Processor 705 may include one or more processing units (e.g., in a multi-core configuration).

Processor 705 may be operatively coupled to a communication interface 715 such that host computing device 702 may be capable of communicating with a remote device such as computing device 602 shown in FIG. 6 or another host computing device 702. For example, communication interface 715 may receive requests from user computing device 602 via the Internet.

Processor 705 may also be operatively coupled to a storage device 725. Storage device 725 may be any computer-operated hardware suitable for storing and/or retrieving data. In some embodiments, storage device 725 may be integrated in host computing device 702. For example, host computing device 702 may include one or more hard disk drives as storage device 725. In other embodiments, storage device 725 may be external to host computing device 702 and may be accessed by a plurality of host computing devices 702. For example, storage device 725 may include multiple storage units such as hard disks or solid state disks in a redundant array of inexpensive disks (RAID) configuration. Storage device 725 may include a storage area network (SAN) and/or a network attached storage (NAS) system.

In some embodiments, processor 705 may be operatively coupled to storage device 725 via a storage interface 720. Storage interface 720 may be any component capable of providing processor 705 with access to storage device 725. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 725.

Memory areas 610 (shown in FIGS. 6) and 710 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

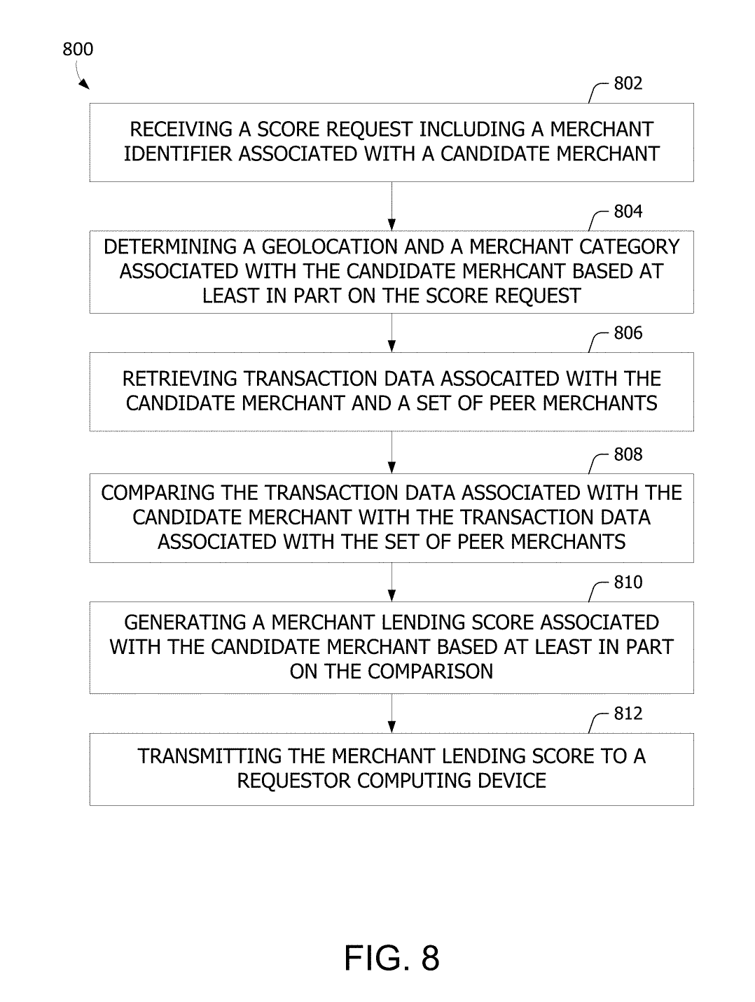

FIG. 8 is a flow diagram of an example method 800 for providing a merchant lending score associated with a candidate merchant using a merchant score system, such as system 100 (shown in FIG. 1). In the example embodiment, method 800 is performed by an MS computing device. In certain embodiments, method 800 may be at least partially performed by a different computing device. In other embodiments, method 800 may include additional, fewer, or alternative actions, including those described elsewhere herein.

Method 800 begins with the MS computing device receiving 802 a score request including merchant identifier from a requestor computing device. The score request and the merchant identifier are associated with a candidate merchant. The MS computing device determines 804 a geolocation (i.e., a geographic region) and a merchant category associated with the candidate merchant based at least in part on the received score request. The MS computing device further retrieves 806 transaction data associated with transactions for a plurality of merchants including the candidate merchant and a set of peer merchants. The peer merchants are associated with the same or similar geolocation and merchant category as the candidate merchant.

The MS computing device compares 808 the transaction data associated with the candidate merchant and the transaction data associated with the set of peer merchants. In at least some embodiments, the MS computing device classifies the transaction data into one or more levels, tiers, and categories to facilitate improved granularity of the analysis. The MS computing device may also apply weighting factors to the transaction data to emphasize transactions with particular characteristics (i.e., ticket size, type of cardholder, etc.). The MS computing device generates 810 a merchant lending score based on the comparison of the transaction data. The MS computing device then transmits 812 the generated merchant lending score to the requestor computing device to facilitate analysis of the candidate merchant and to determine whether or not to approve a loan request from the candidate merchant based on the merchant lending score.

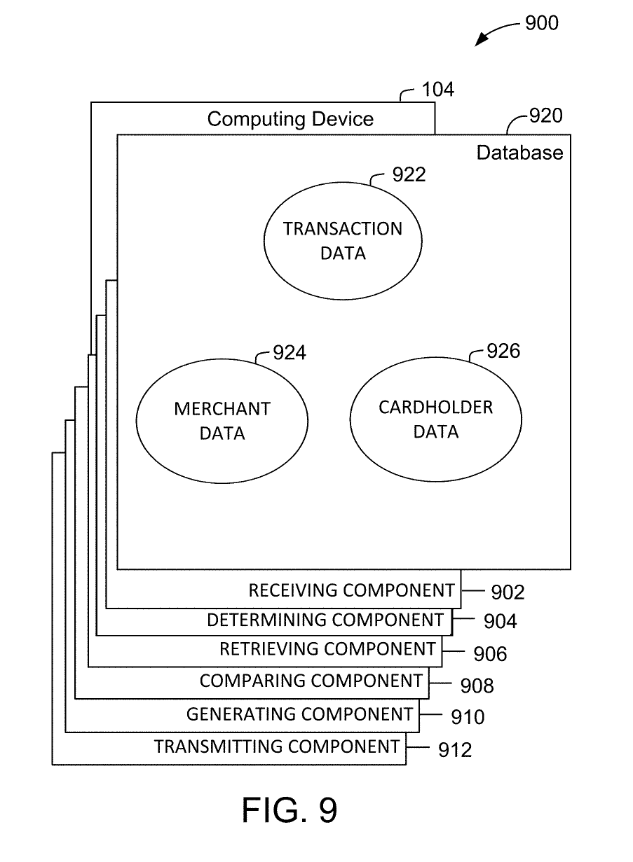

FIG. 9 is a diagram 900 of components of one or more example computing devices that may be used in the method shown in FIG. 8. FIG. 9 further shows a configuration of a database system 920 including at least transaction database 106 (shown in FIG. 1). Database system 920 is coupled to several separate components within MS computing device 104 (shown in FIG. 1), which perform specific tasks.

MS computing device 104 includes a receiving component 902 configured to receive a score request associated with a candidate merchant from a requestor computing device. MS computing device 104 further comprises a determining component 904 configured to determine a geolocation and a merchant category associated with the candidate merchant based at least in part on the score request. MS computing device 104 further includes a retrieving component 906 configured to retrieve transaction data associated with the candidate merchant and a set of peer merchants. MS computing device 104 also includes a comparing component 908 configured to compare the transaction data associated with the candidate merchant to the transaction data associated with the set of peer merchants. MS computing device 104 further includes a generating component 910 configured to generate a merchant lending score associated with the candidate merchant based at least in part on the comparison of transaction data. MS computing device 104 also includes a transmitting component 912 configured to transmit the merchant lending score to the requestor computing device.

In an exemplary embodiment database system 920 is divided into a plurality of sections, including but not limited to, a transaction data section 922, a merchant data section 924, and a cardholder data section 926. Database system 920 is interconnected to MS computing device 104 to update and retrieve the information as required.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A merchant score (MS) computing device for generating merchant lending scores for business loans, the MS computing device comprising a processor and a memory device in communication with the processor, the processor programmed to:
receive, from a requestor computing device, a score request including a merchant identifier associated with a candidate merchant;
determine a geolocation and a merchant category associated with the candidate merchant based at least in part on the score request;
retrieve transaction data associated with transactions for a plurality of merchants including the candidate merchant and a set of peer merchants, each merchant of the set of peer merchants associated with the determined geolocation and merchant category of the candidate merchant;
compare the transaction data associated with the candidate merchant to the transaction data associated with the set of peer merchants;
generate a merchant lending score associated with the candidate merchant based on the comparison, wherein the merchant lending score indicates a relative performance level of the candidate merchant; and
transmit the merchant lending score to the requestor computing device.

2. The MS computing device in accordance with claim 1, wherein the processor is further programmed to:
classify the transaction data into a plurality of transaction levels based on a ticket size for each transaction associated with the transaction data;
determine a candidate transaction volume associated with the candidate merchant for each level of the plurality of transaction levels; and
generate the merchant lending score at least partially as a function of the determined candidate transaction volumes.

3. The MS computing device in accordance with claim 2, wherein the processor is further programmed to:
determine a model transaction volume associated with the set of peer merchants for each level of the plurality of transaction levels, wherein the model transaction volume is an average of transaction volumes associated with each merchant of the set of peer merchants;
generate a plurality of volume scores associated with the plurality of transaction levels, each volume score of the plurality of volume scores is generated by comparing a respective candidate transaction volume of the candidate transaction volumes and a respective model transaction volume of the model transaction volumes; and
generate the merchant lending score at least partially as a function of the plurality of volume scores.

4. The MS computing device in accordance with claim 2, wherein the processor is further programmed to:
apply a plurality of predetermined weighting factors to the candidate transaction volumes; and
generate the merchant lending score at least partially as a function of the candidate transaction volumes and the plurality of predetermined weighting factors.

5. The MS computing device in accordance with claim 1, wherein the transaction data includes an account identifier for each transaction of the transaction data, the processor further programmed to:
retrieve a cardholder tier table storing cardholder tier information associated with a plurality of cardholders, the cardholder tier information for each cardholder of the plurality of cardholders indicating a spending level of the cardholder;
identify a cardholder tier for each transaction of the transaction data by performing a lookup of the account identifiers in the cardholder tier table;
classify the transaction data into the identified cardholder tiers of the transactions;
determine a candidate transaction volume associated with the candidate merchant for each tier of the identified cardholder tiers; and
generate the merchant lending score at least partially as a function of the determined candidate transaction volumes.

6. The MS computing device in accordance with claim 1, wherein the processor is further programmed to:
determine, for each transaction associated with the transaction data, if a cardholder associated with the transaction is a new customer or a repeat customer at a merchant of the plurality of merchants associated with the transaction; and
determine a first candidate transaction volume associated with the candidate merchant for transactions at the candidate merchant associated with new customers;
determine a second candidate transaction volume associated with the candidate merchant for transactions at the candidate merchant associated with repeat customers; and
generate the merchant lending score at least partially as a function of the first candidate transaction volume and the second candidate transaction volume.

7. The MS computing device in accordance with claim 1, wherein the score request includes at least one of a geolocation identifier and a merchant category identifier.

8. The MS computing device in accordance with claim 1, wherein the merchant lending score is transmitted to the requestor computing device in response to the score request in near-real time.

9. The MS computing device in accordance with claim 1, wherein the processor is further programmed to:
generate a recommendation associated with the candidate merchant by comparing the merchant lending score to at least one predetermined threshold, the recommendation recommending to approve or decline the candidate merchant for a business loan; and
transmit the recommendation with the merchant lending score to the requestor computing device, wherein a lending party associated with the requestor computing device approves or declines the candidate merchant for the business loan based at least in part on the recommendation.

10. A method for generating a merchant lending score associated with a candidate merchant, the method comprising:
receiving, by a merchant score (MS) computing device, a score request from a requestor computing device, the score request including a merchant identifier associated with a candidate merchant;
determining a geolocation and a merchant category associated with the candidate merchant based at least in part on the score request;
retrieving, by the MS computing device, transaction data associated with transactions for a plurality of merchants including the candidate merchant and a set of peer merchants, each merchant of the set of peer merchants associated with the determined geolocation and merchant category of the candidate merchant;
comparing the transaction data associated with the candidate merchant to the transaction data associated with the set of peer merchants;
generating, by the MS computing device, a merchant lending score associated with the candidate merchant based on the comparison, wherein the merchant lending score indicates a relative performance level of the candidate merchant; and
transmitting the merchant lending score to the requestor computing device.

11. The method in accordance with claim 10, wherein comparing the transaction data and generating the merchant lending score further comprises:
classifying, by the MS computing device, the transaction data into a plurality of transaction levels based on a ticket size for each transaction associated with the transaction data;
determining a candidate transaction volume associated with the candidate merchant for each level of the plurality of transaction levels; and
generating, by the MS computing device, the merchant lending score at least partially as a function of the determined candidate transaction volumes.

12. The method in accordance with claim 11, wherein comparing the transaction data and generating the merchant lending score further comprises:
determining a model transaction volume associated with the set of peer merchants for each level of the plurality of transaction levels, wherein the model transaction volume is an average of transaction volumes associated with each merchant of the set of peer merchants;
generating, by the MS computing device, a plurality of volume scores associated with the plurality of transaction levels, each volume score of the plurality of volume scores is generated by comparing a respective candidate transaction volume of the candidate transaction volumes and a respective model transaction volume of the model transaction volumes; and
generating the merchant lending score at least partially as a function of the plurality of volume scores.

13. The method in accordance with claim 11, wherein generating the merchant lending score further comprises:
applying a plurality of predetermined weighting factors to the candidate transaction volumes; and
generating the merchant lending score at least partially as a function of the candidate transaction volumes and the plurality of predetermined weighting factors.

14. The method in accordance with claim 10, wherein the transaction data includes an account identifier for each transaction of the transaction data, wherein comparing the transaction data and generating the merchant lending score further comprises:
retrieving, by the MS computing device, a cardholder tier table storing cardholder tier information associated with a plurality of cardholders, the cardholder tier information for each cardholder of the plurality of cardholders indicating a spending level of the cardholder;
identifying a cardholder tier for each transaction of the transaction data by performing a lookup of the account identifiers in the cardholder tier table;
classifying, by the MS computing device, the transaction data into the identified cardholder tiers of the transactions;
determining a candidate transaction volume associated with the candidate merchant for each tier of the identified cardholder tiers; and
generating the merchant lending score at least partially as a function of the determined candidate transaction volumes.

15. The method in accordance with claim 10, wherein comparing the transaction data and generating the merchant lending score further comprises:
determining, for each transaction associated with the transaction data, if a cardholder associated with the transaction is a new customer or a repeat customer at a merchant of the plurality of merchants associated with the transaction; and
determining a first candidate transaction volume associated with the candidate merchant for transactions at the candidate merchant associated with new customers;
determining a second candidate transaction volume associated with the candidate merchant for transactions at the candidate merchant associated with repeat customers; and
generating the merchant lending score at least partially as a function of the first candidate transaction volume and the second candidate transaction volume.

16. The method in accordance with claim 10, wherein the score request includes at least one of a geolocation identifier and a merchant category identifier.

17. The method in accordance with claim 10, wherein transmitting the merchant lending score further comprises:
generating, by the MS computing device, a recommendation associated with the candidate merchant by comparing the merchant lending score to at least one predetermined threshold, the recommendation recommending to approve or decline the candidate merchant for a business loan; and
transmitting the recommendation with the merchant lending score to the requestor computing device, wherein a lending party associated with the requestor computing device approves or declines the candidate merchant for the business loan based at least in part on the recommendation

18. At least one non-transitory computer-readable storage media having computer-executable instructions embodied thereon, wherein when executed by at least one processor, the computer-executable instructions cause the processor to:
receive, from a requestor computing device, a score request including a merchant identifier associated with a candidate merchant;
determine a geolocation and a merchant category associated with the candidate merchant based at least in part on the score request;
retrieve transaction data associated with transactions for a plurality of merchants including the candidate merchant and a set of peer merchants, each merchant of the set of peer merchants associated with the determined geolocation and merchant category of the candidate merchant;
compare the transaction data associated with the candidate merchant to the transaction data associated with the set of peer merchants;
generate a merchant lending score associated with the candidate merchant based on the comparison, wherein the merchant lending score indicates a relative performance level of the candidate merchant; and
transmit the merchant lending score to the requestor computing device.

19. The computer-readable storage media in accordance with claim 18, wherein the computer-executable instructions further cause the processor to:
classify the transaction data into a plurality of transaction levels based on a ticket size for each transaction associated with the transaction data;
determine a candidate transaction volume associated with the candidate merchant for each level of the plurality of transaction levels; and
generate the merchant lending score at least partially as a function of the determined candidate transaction volumes.

20. The computer-readable storage media in accordance with claim 19, wherein the computer-executable instructions further cause the processor to:
determine a model transaction volume associated with the set of peer merchants for each level of the plurality of transaction levels, wherein the model transaction volume is an average of transaction volumes associated with each merchant of the set of peer merchants;
generate a plurality of volume scores associated with the plurality of transaction levels, each volume score of the plurality of volume scores is generated by comparing a respective candidate transaction volume of the candidate transaction volumes and a respective model transaction volume of the model transaction volumes; and
generate the merchant lending score at least partially as a function of the plurality of volume scores.

21. The computer-readable storage media in accordance with claim 19, wherein the computer-executable instructions further cause the processor to:
apply a plurality of predetermined weighting factors to the candidate transaction volumes; and
generate the merchant lending score at least partially as a function of the candidate transaction volumes and the plurality of predetermined weighting factors.

22. The computer-readable storage media in accordance with claim 18, wherein the transaction data includes an account identifier for each transaction of the transaction data, the computer-executable instructions further cause the processor to:
retrieve a cardholder tier table storing cardholder tier information associated with a plurality of cardholders, the cardholder tier information for each cardholder of the plurality of cardholders indicating a spending level of the cardholder;
identify a cardholder tier for each transaction of the transaction data by performing a lookup of the account identifiers in the cardholder tier table;
classify the transaction data into the identified cardholder tiers of the transactions;
determine a candidate transaction volume associated with the candidate merchant for each tier of the identified cardholder tiers; and
generate the merchant lending score at least partially as a function of the determined candidate transaction volumes.

23. The computer-readable storage media in accordance with claim 18, wherein the computer-executable instructions further cause the processor to:
determine, for each transaction associated with the transaction data, if a cardholder associated with the transaction is a new customer or a repeat customer at a merchant of the plurality of merchants associated with the transaction; and
determine a first candidate transaction volume associated with the candidate merchant for transactions at the candidate merchant associated with new customers;
determine a second candidate transaction volume associated with the candidate merchant for transactions at the candidate merchant associated with repeat customers; and
generate the merchant lending score at least partially as a function of the first candidate transaction volume and the second candidate transaction volume.

24. The computer-readable storage media in accordance with claim 18, wherein the computer-executable instructions further cause the processor to:
generate a recommendation associated with the candidate merchant by comparing the merchant lending score to at least one predetermined threshold, the recommendation recommending to approve or decline the candidate merchant for a business loan; and
transmit the recommendation with the merchant lending score to the requestor computing device, wherein a lending party associated with the requestor computing device approves or declines the candidate merchant for the business loan based at least in part on the recommendation.
